(19) United States
(12) Patent Application Publication
(10) Pub. No.: US 2024/0086723 A1
(43) Pub. Date: Mar. 14, 2024

(54) FIELD PRODUCTION STRATEGY OPTIMIZATION USING MULTI-OBJECTIVE GENETIC ALGORITHM

(71) Applicant: Saudi Arabian Oil Company, Dhahran (SA)

(72) Inventors: Zeid M. Al-Ghareeb, Dhahran (SA); Zainab Al-Ali, Dammam (SA)

(73) Assignee: Saudi Arabian Oil Company, Dhahran (SA)

(21) Appl. No.: 18/500,472

(22) Filed: Nov. 2, 2023

Related U.S. Application Data
(63) Continuation-in-part of application No. 17/243,826, filed on Apr. 29, 2021.

(51) Int. Cl. G06N 3/126

(52) U.S. Cl. CPC G06N 3/126

(57) ABSTRACT

Systems and methods for operating wells of a field using a multi-objective genetic algorithm are disclosed. In one embodiment, a method of operating a plurality of wells within a field includes determining an oil rate for each well of the plurality of wells by a multi-objective genetic algorithm. The multi-objective genetic algorithm is defined by a multi-objective fitness function including a first objective function that meets a target oil rate for the field and a second objective function that maximizes bottom-hole reservoir pressure, maximizes a distance of the wells to a crest line of the field, and minimizes a water cut of the field. The multi-objective genetic algorithm outputs the oil rate for each well that satisfies the multi-objective fitness function. The method further includes operating the plurality of wells at the oil rate for each well.

### CROSS-REFERENCE TO RELATED APPLICATIONS

This application is a continuation-in-part of U.S. patent application Ser. No. 17/243,826 entitled “Field Production Strategy Optimization Using Multi-Objective Genetic Algorithm” filed on Apr. 29, 2021, which is hereby incorporated by reference in its entirety.

### BACKGROUND

In the oil and gas industry, it may be desirable to maximize production and recovery from hydrocarbon fields through the implementation of strategically designed field development plans and reservoir production strategies. Hydrocarbon fields include many, many wells, all of which should be controlled to meet certain requires of a production strategy. Therefore, wells are individually controlled to achieve the desired result. Calculation of production parameters for each well, such as oil production rate, is computationally expensive and also manually intensive.

Accordingly, alternative systems and methods for operating a plurality of wells of a hydrocarbon field are desired.

### SUMMARY

Embodiments of the present disclosure are directed to systems and methods for operating a plurality of wells of a field, as well as systems and methods for determining oil rates for a plurality of wells of a field. A multi-objective genetic algorithm receives input data and determines one or more solution sets having an output that includes well product rates for the plurality of wells within the field. User-provided constraints define surface factors of the field, and user-provided global weight factors define a desired production strategy for the field.

In one embodiment, a method of operating a plurality of wells within a field includes generating, using well monitoring hardware, well data from the plurality of wells, and determining, using an oil rate updater, an oil rate for each well of the plurality of wells by the well data and a multi-objective genetic algorithm. The multi-objective genetic algorithm is defined by a multi-objective fitness function having a first objective function that meets a target oil rate for the field and a second objective function that maximizes bottom-hole reservoir pressure, maximizes a distance of individual wells to a crest line of the field, and minimizes a water cut of the field. The multi-objective genetic algorithm outputs the oil rate for each well that satisfies the multi-objective fitness function. The method further includes translating, using an oil rate translation module, the oil rate for each well that satisfies the multi-objective fitness function for use by one or more well components of the plurality of wells, and operating the one or more well components of the plurality of wells at the oil rate for each well.

In another embodiment, a system for operating a plurality of wells within a field includes one or more well components for each well of the plurality of wells, well monitoring hardware that generates well data from the plurality of wells, and an a field oil rate computing system. The field oil rate computing system includes a well data memory that receives and stores the well data from the well monitoring hardware and an oil rate updater that determines an oil rate for each well of the plurality of wells by a multi-objective genetic algorithm. The multi-objective genetic algorithm is defined by a multi-objective fitness function including a first objective function that meets a target oil rate for the field and a second objective function that maximizes bottom-hole reservoir pressure, maximizes a distance of the wells to a crest line of the field, and minimizes a water cut of the field. The multi-objective genetic algorithm outputs the oil rate for each well that satisfies the multi-objective fitness function. The field oil rate computing system further includes an oil rate translation module that translates the oil rate for each well that satisfies the multi-objective fitness function for use by the one or more well components of the plurality of wells, wherein the one or more well components are operated based on the oil rate for each well of the plurality of wells.

It is to be understood that both the foregoing general description and the following detailed description present embodiments that are intended to provide an overview or framework for understanding the nature and character of the claims. The accompanying drawings are included to provide a further understanding of the disclosure, and are incorporated into and constitute a part of this specification. The drawings illustrate various embodiments and together with the description serve to explain the principles and operation.

### BRIEF DESCRIPTION OF THE DRAWINGS

FIG. 1 schematically illustrates three different production strategies of a field according to one or more embodiments described and illustrated herein;

FIG. 2 is a flowchart illustrating an example method of operating wells of a field according to one or more embodiments described and illustrated herein;

FIG. 3 is a graph illustrating oil rate of example trunklines of a field according to one or more embodiments described and illustrated herein;

FIG. 4 is a graph illustrating production rates for individual groups of wells of a field according to one or more embodiments described and illustrated herein;

FIG. 5 schematically illustrates a mixed production strategy of a field according to one or more embodiments described and illustrated herein;

FIG. 6 is a histogram showing the number of wells operating within a production range resulting from oil rates determined by a multi-objective genetic algorithm according to one or more embodiments described and illustrated herein;

FIG. 7 is a histogram showing the number of wells operating within a production range according to a potential oil rate according to one or more embodiments described and illustrated herein;

FIG. 8A schematically illustrates a drilling system according to one or more embodiments described and illustrated herein; and

FIG. 8B schematically illustrates an example computing device for performing the functionalities described herein according to one or more embodiments described and illustrated herein.

### DETAILED DESCRIPTION OF THE DISCLOSURE

Embodiments of the present disclosure are directed to systems and methods for operating wells of a hydrocarbon field. In the oil and gas industry, a goal may be to achieve hydrocarbon production and recovery targets from hydrocarbon fields through the implementation of strategically designed field development plans and reservoir production strategies. In embodiments, under waterflooding schemes, reservoir strategies are designed to ensure a uniform movement of flood front while optimizing the reservoir pressure of the field and minimizing the production of water at the surface to achieve an oil production sustainably, prolonging the field's life and preventing excessive water production. To ensure that these strategies are implemented in the field, engineers are required to allocate production rates to individual wells and manually cross-validate these reservoir strategies while capturing all surface constraints in the field, such as the minimum and maximum rates of a production trunkline, train or a crude separation facility. Typically, engineers must compile, check and analyze multiple reservoir parameters including: the well's locations, bottom-hole pressure, oil maximum potential rates, and water cut. These calculations are performed for each well to assign a production target that meets the overall reservoir strategy of the field. This task is usually computationally expensive because many individual calculations must be executed, as well as labor-intensive and time consuming. Thus, the task may take many days to complete. Additionally, this process, when done manually, may produce inconsistent results over the long run and is prone to human errors.

Embodiments of the present disclosure improve the computational efficiency of determining well production rates, and minimize manual involvement by use of a multi-objective genetic algorithm that automates the process, thereby ensuring the targeted production strategy is captured. Generally, embodiments provide systems and methods for receiving as input well data, and also global weight factors that define a production strategy and constraints defining characteristics of the field, such as trunkline and production facility characteristics. A multi-objective genetic algorithm receives the inputs and determines one or more solution sets having an output that includes well product rates for the plurality of wells within the field.

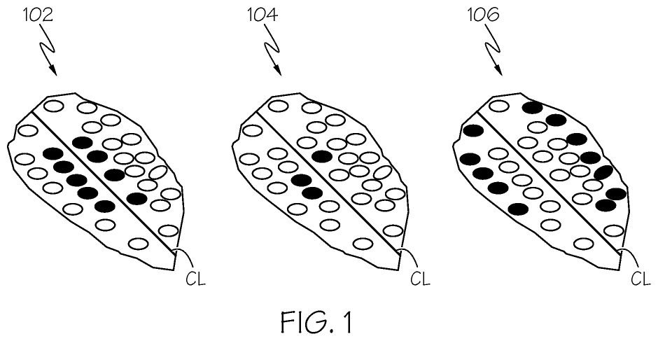

As stated above, the global weight factors are used to define a production strategy. Non limiting production strategies include a wet strategy, a dry strategy, and a mixed strategy. Referring now to FIG. 1, a wet production strategy 102, a mixed production strategy 104, and a dry production strategy 106 for a field are partially illustrated. In each strategy, a crest line CR is provided through the center of the field. The crest line CR may be generally aligned with the crest of the particular field. In the wet production strategy 102, wells near the flank (i.e., the edges of the field) and furthest from crest line CR are opened and prioritized. In FIG. 1, wells that are opened are indicated by a non-shaded circle and wells that are shut in are indicated by a shaded circle. The dry production strategy 106 opens and prioritizes the wells closest to the crest line CR. In this strategy, production starts from the middle of the field and moves toward the flanks. The mixed production strategy 104 prioritizes wells near the flanks like the wet production strategy 102 but takes into consideration other factors, for example pressure, well location with respect to the crest of the reservoir, and water cut, and may therefore open wells close to the crest line CR.

Embodiments described herein automatically, and without user intervention, calculate optimum production rates for wells of the field in accordance with satisfying simultaneous objectives: honoring a target production rate for the field (i.e., meeting the target production rate within 90% or more), maximizing bottom-hole reservoir pressure, maximizing a distance of the wells to a crest line of the field, and minimizing a water cut of the field.

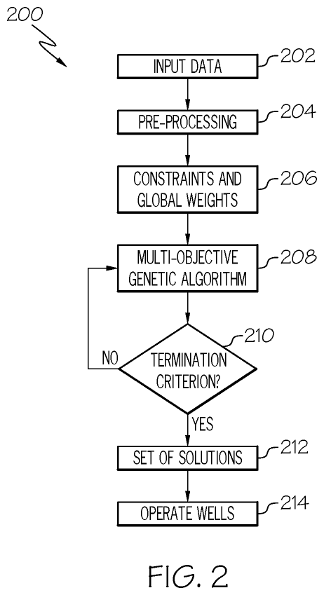

Referring now to FIG. 2, flowchart 200 illustrating a non-limiting example method for operating a plurality of wells is provided. It should be understood that the method may include more, fewer or different steps than as shown by FIG. 2.

At block 202, input data regarding wells of the field are received by the system, which may be a computing device such as a desktop computer. The input data may be provided by any means. For example, a user may input the input data manually into the system, or the input data may be automatically read into the system. Non-limiting example input data includes wells' distance to the central up-structure location of the field (i.e., CR line), bottom hole pressure, wells' location, oil maximum potential rate, and water cut. Table 1 below shows non-limiting example input data.

TABLE 1

| | | | Oil | Water | | | | pressure | | | | |
|---|---|---|---|---|---|---|---|---|---|---|---|---|
| Wells | Trunkline | Field | Rate | Rate | WC | X | Y | intake | SBHP | Crest | Longitude | Latitude |
| wells- | TR/L-8 | A | 1000 | 100 | 93 | 20000 | 5625000 | 1200 | 1665.97464 | 1405.70896 | 40 | 25 |
| 1 | | | | | | | | | | | | |
| Wells- | TR/L-10 | A | 1000 | 100 | 92 | 20000 | 5625000 | 1200 | 2356 | 1591.11943 | 40 | 25.0608 |
| 2 | | | | | | | | | | | | |
| Wells- | TR/L-9 | A | 1000 | 100 | 87 | 20000 | 5625000 | 1200 | 1976 | 1394.75292 | 40 | 25.0608 |
| 3 | | | | | | | | | | | | |
| Wells- | TR/L-6 | A | 1000 | 100 | 85 | 20000 | 5625000 | 1200 | 1801.46658 | 5078.96079 | 40 | 25.0608 |
| 4 | | | | | | | | | | | | |
| Wells- | TR/L-3 | A | 1000 | 100 | 85 | 20000 | 5625000 | 1200 | 1751.82444 | 2069.54818 | 40 | 25.0608 |
| 5 | | | | | | | | | | | | |
| Wells- | TR/L-6 | A | 1000 | 100 | 85 | 20000 | 5625000 | 1200 | 1575.96731 | 6840.26406 | 40 | 25.0608 |
| 6 | | | | | | | | | | | | |
| Wells- | TR/L-6 | A | 1000 | 100 | 85 | 20000 | 5625000 | 1200 | 1936.3884 | 7448.94009 | 40 | 25.0608 |
| 7 | | | | | | | | | | | | |
| Wells- | TR/L-12 | A | 1000 | 100 | 83 | 20000 | 5625000 | 1200 | 3385.25601 | 10351.548 | 40 | 25.0608 |
| 8 | | | | | | | | | | | | |
| Wells- | TR/L-5 | A | 1000 | 100 | 83 | 20000 | 5625000 | 1200 | 2069 | 364.76094 | 40 | 25.0608 |
| 9 | | | | | | | | | | | | |
| Wells- | TR/L-6 | A | 1000 | 100 | 80 | 20000 | 5625000 | 1200 | 1595.38772 | 5316.11075 | 40 | 25.0608 |
| 10 | | | | | | | | | | | | |
| Wells- | TR/L-13 | A | 1000 | 100 | 80 | 20000 | 5625000 | 1200 | 2210 | 1778.81545 | 40 | 25.0608 |
| 11 | | | | | | | | | | | | |
| Wells- | TR/L-12 | A | 1000 | 100 | 80 | 20000 | 5625000 | 1200 | 2079.74601 | 2029.64578 | 40 | 25.0608 |
| 12 | | | | | | | | | | | | |
| Wells- | TR/L-8 | A | 1000 | 100 | 80 | 20000 | 5625000 | 1200 | 1626 | 3204.68752 | 40 | 25.0608 |
| 13 | | | | | | | | | | | | |
| Wells- | TR/L-2 | A | 1000 | 100 | 77 | 20000 | 5625000 | 1200 | 1497 | 2599.51739 | 40 | 25.0608 |
| 14 | | | | | | | | | | | | |
| Wells- | TR/L-4 | A | 1000 | 100 | 77 | 20000 | 5625000 | 1200 | 1886.10504 | 825.929179 | 40 | 25.0608 |
| 15 | | | | | | | | | | | | |
| Wells- | TR/L-11 | A | 1000 | 100 | 75 | 20000 | 5625000 | 1200 | 2730.55159 | 11018.4035 | 40 | 25.0608 |
| 16 | | | | | | | | | | | | |
| Wells- | TR/L-7 | A | 1000 | 100 | 75 | 20000 | 5625000 | 1200 | 1476 | 3773.65919 | 40 | 25.0608 |
| 17 | | | | | | | | | | | | |
| Wells- | TR/L-9 | A | 1000 | 100 | 74 | 20000 | 5625000 | 1200 | 1620 | 1891.65452 | 40 | 25.0608 |
| 18 | | | | | | | | | | | | |
| Wells- | TR/L-11 | A | 1000 | 100 | 74 | 20000 | 5625000 | 1200 | 2204 | 11577.268 | 40 | 25.0608 |
| 19 | | | | | | | | | | | | |
| Wells- | TR/L-7 | A | 1000 | 100 | 74 | 20000 | 5625000 | 1200 | 1479 | 5714.51081 | 40 | 25.0608 |
| 20 | | | | | | | | | | | | |
| Wells- | TR/L-9 | A | 1000 | 100 | 73 | 20000 | 5625000 | 1200 | 1789.48335 | 640.322768 | 40 | 25.0608 |
| 21 | | | | | | | | | | | | |
| Wells- | TR/L-12 | A | 1000 | 100 | 72 | 20000 | 5625000 | 1200 | 2365 | 2240.36891 | 40 | 25.0608 |
| 22 | | | | | | | | | | | | |
| Wells- | TR/L-12 | A | 1000 | 100 | 72 | 20000 | 5625000 | 1200 | 3489.2208 | 8032.13083 | 40 | 25.0608 |
| 23 | | | | | | | | | | | | |
| Wells- | TR/L-7 | A | 1000 | 100 | 72 | 20000 | 5625000 | 1200 | 1357 | 6665.16558 | 40 | 25.0608 |
| 24 | | | | | | | | | | | | |
| Wells- | TR/L-10 | A | 1000 | 100 | 72 | 20000 | 5625000 | 1200 | 2018 | 9450.90376 | 40 | 25.0608 |
| 25 | | | | | | | | | | | | |

The Wells column includes a well identifier, the Trunkline column includes a trunkline identifier, the Field column includes a field identifier, the Oil Rate column includes the oil rate for each well, the Water Rate column includes the water rate for each well, the WC column includes the water cut for each well, the X column includes the UTMX coordinate for each well, the Y column includes the UTMY coordinate for each well, the Pressure Intake column includes the pressure intake for each well, the SBHP column includes the static bottom-hole pressure for each well, the Crest column includes the distance of the well from the crest line CR, the Longitude column includes the longitude coordinate for each well, and the Latitude column includes the latitude coordinate for each well. It should be understood that embodiments are not limited to the input data provided by Table 1.

In some embodiments, at block 204 pre-processing is performed on the input data where all the input data are normalized between 0 and 1 to avoid any data bias. However, it should be understood that no pre-processing may be done in other embodiments.

Next, at block 206, constraints and global weight factors are received by the system. In some embodiments, a user may enter the constraints into the system. Additionally or alternatively, constraints may be automatically downloaded into the system. The constraints define aspects of the field, and may be operational and/or non-linear. For example, surface constraints, such as trunkline maximum and minimum rates, maximum rates of a production facility, back pressure in the well head, ESP minimum operating rates and the like are defined as non-linear constraints in the system. The trunkline minimum rates are the minimum rate that hydrocarbons can flow through the respective trunklines. The maximum rate of a production facility is the maximum rate of hydrocarbons that can be processed by the production facility. Other operating conditions may be specified, such as the minimum operating bottom-hole pressure for each well.

Global weight factors may also be received by the system. As described in more detail below, the global weight factors are introduced into the multi-objective fitness function and can be inputted by the user to define the targeted strategy.

Next, at block 208, the input data, constraints, and global weight factors are provided to the multi-objective genetic algorithm. The multi-objective genetic algorithm comprises a multi-objective fitness function that is defined by two objective functions y₁ and y₂, non-limiting examples of which are provided below.

$${y}_{1} = absolute ( {q}_{Target} - {\sum }_{i = 1}^{N} {q}_{o i} {x}_{i} )$$

$${y}_{2} = {\sum }_{i = 1}^{N} {x}_{i} ( {a}_{1} \times {P}_{{norm}_{i}} + {a}_{2} \times {d}_{{norm}_{i}} + {a}_{3} \times {WC}_{{norm}_{i}} ) ,$$

where:
xᵢ: lower and upper bound of the decision variable of the multi-objective genetic algorithm, representing the well's choke size,
q_{Target}: the oil target rate of the field,
qₒᵢ: the maximum potential oil rate per well,
N: total number of wells in the field,
Pₙₒᵣₘ_{ᵢ}: normalized reservoir pressure per well,
dₙₒᵣₘ_{ᵢ}: normalized well's distance to the crestal line of the field,
WCₙₒᵣₘ_{ᵢ}: normalized water cut per well,
a₁: global weight factor for the normalized pressure variable,
a₂: global weight factor for the normalized distance variable, and
a₃: global weight factor for the normalized water cut variable

The first fitness function y₁ honors a target oil rate for the field, and the second objective function y₂ maximizes bottom-hole reservoir pressure, maximizes a distance of the wells to a crest line of the field, and minimizes a water cut of the field.

As stated above, the global weight factors are introduced into the objective function and define a production strategy that can be optimized by adjusting these global weight factors. For example, to generate a wet production strategy with a uniform production from flank to crest of the field, the pressure and the water cut weights, a₁ and a₃, respectively, are set to 0. The multi-objective genetic algorithm will only use the distance to allocate the individual well's target and will produce the field from flank to crest. For a dry production strategy, a₁ and a₂ should be set to zero because the field will be produced based on the water rate, where wells with high water cut will be restricted by the multi-objective genetic algorithm. For a mixed production strategy, the weights are set for all factors based on a pre-knowledge of the reservoir information and heterogeneity. Multiple sensitivity tests may be run to determine the weights. Each result may be compared with a target rate that was generated by engineers previously. By setting the correct weights, the multi-objective genetic algorithm will produce the field not only based on location, but also look at other variables including, without limitation: pressure, water cut and distance to produce the optimal production strategy. Furthermore, other localized weights can also be introduced per selected group(s) of wells. For example, a local pressure and distance weight factor can be defined per group based on the wells' performance and knowledge of pressure and distance distribution before applying the global weight factors.

The multi-objective fitness function is defined to honor the field's target rate (y₁), maximize the bottom-hole reservoir pressure, maximize the distance to the crest line location of the field and minimize the field's overall water cut (y₂). The multi-objective genetic algorithm generates initial candidate solutions that are tested against the multi-objective fitness function. As an example and not a limitation, the multi-objective genetic algorithm may be executed using the gamultiobj function in MATLAB provided by MathWorks of Natick, Massachusetts. The multi-objective genetic algorithm will produce a new generation of solutions to search for best candidates by applying multiple genetic algorithm processes involving selection, cross-over and mutation. The multi-objective genetic algorithm captures all the facility constraints defined by the user. For example, wells with an oil rate less than 800 bbl of oil and water cut higher than 80% will be closed, the minimum rate per trunk line is 20 MBD and the GOSP minimum operation rate is 110 MBD.

Based on this genetic process, optimum scenarios are selected by the multi-objective genetic algorithm achieving the multi-objective genetic algorithm's objectives and meeting the multi-objective fitness function. At block 210, it is determined whether or not the multi-objective fitness function termination criterion are satisfied. That is, it is determined whether or not the target rate is honored, the bottom-hole reservoir pressure is maximized, a distance of the wells to a crest line of the field is maximized, and a water cut of the field is minimized. If not, the process produces another generation of solutions which are generated and evaluated by moving back to block 208 and continuing again to block 210.

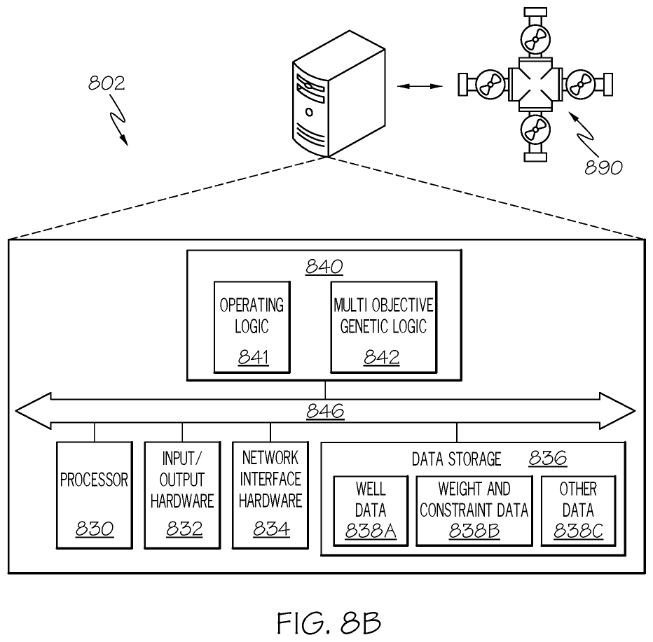

Once the multi-objective fitness function termination criterion are satisfied at block 210, the process moves to block 212, where a set of solutions is outputted. The set of solutions includes the oil rate for each well within the field. These oil rates are then applied to the individual wells such that the wells are operated according to the assigned oil rates. For example, well components 890 (see FIGS. 8A and 8B), such as a wellhead choke, are operated so that the wells operate at the desired oil rates.

Accordingly, embodiments enable quick and efficient calculation of oil rates to effectuate a production strategy for a field that significantly reduces the amount of computing power and human time required by traditional methods.

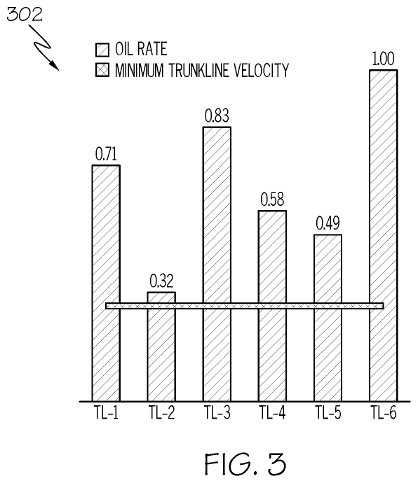

Referring now to FIG. 3, a graph 302 illustrating trunkline oil rate (i.e., oil velocity) as a percentage of a total oil rate for six example trunklines TL-1-TL6, and how each trunkline is above a minimum oil rate as defined by a user, which in this case is 30% of a total oil rate of the particular trunklines. The minimum trunkline oil rate is a non-linear constraint selected by the user. As shown by the graph 302, the oil rates of the wells outputted by the multi-objective genetic algorithm ensure that the non-linear constraint of the minimum trunkline oil rate is satisfied.

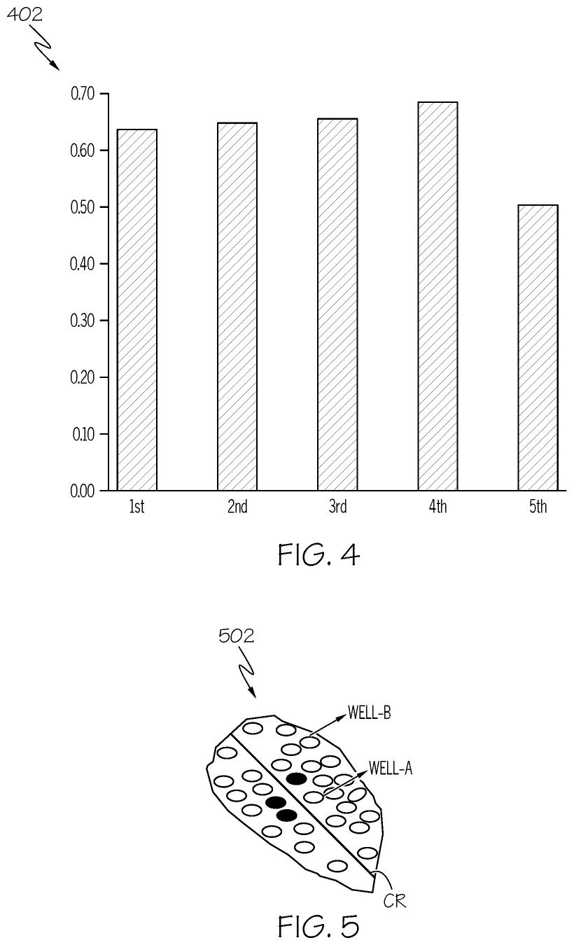

FIG. 4 is a graph 402 illustrating production rates for groups of wells per oil rates determined by the multi-objective genetic algorithm under a mixed production strategy example. The multi-objective genetic algorithm provided a uniform flood front from flank to crest of the field. The wells were grouped in rows, wherein the 1^{st} group includes the wells closest to the flank of the field, followed by the 2^{nd}, 3^{rd}, 4^{th} and 5^{th} group of wells, which are increasingly further from the flank of the field. The Y-axis of the graph 402 is the percentage of wells producing oil in each group. Thus, the percentage of each bar of the graph 402 represents the optimized production obtained from the multi-objective genetic algorithm over the total production potential of the particular production row. The multi-objective genetic algorithm will produce evenly from all wells in the field to ensure a uniform production from flank to crest. In keeping with the mixed production strategy, the wells of the 5^{th} group, which are furthest from the flank, produce less than the wells of the other groups.

FIG. 5 illustrates a mixed production strategy 502 of a field. The well labeled Well-A has a lower pressure and is located further updip as compared to the well labeled Well-B. As such, the output of the multi-objective genetic algorithm will automatically choke Well-A more than Well-B.

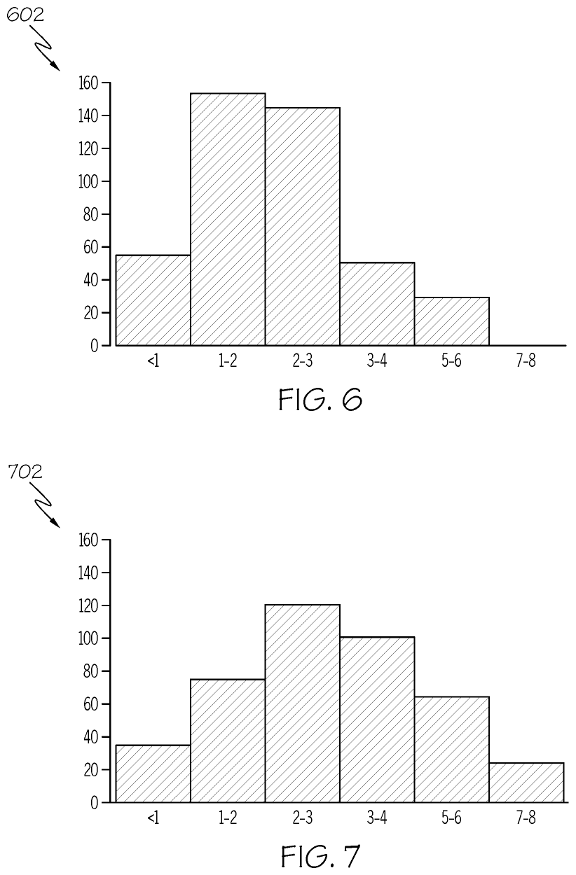

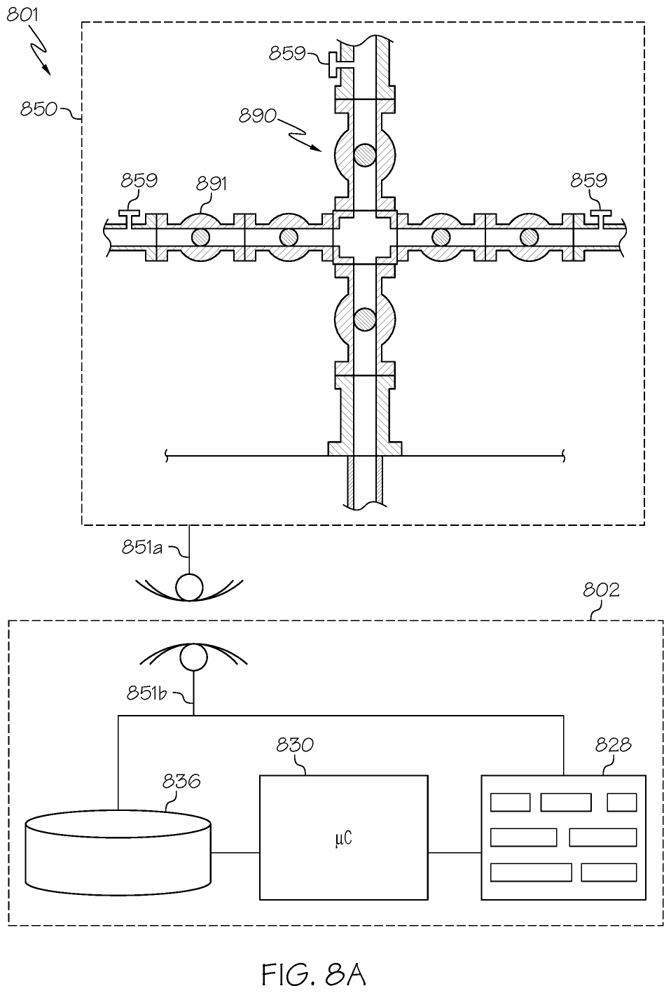

FIGS. 6 and 7 show the normalized distribution of oil rates versus well count from both the multi-objective genetic algorithm and originally inputted oil rate potential for wells within the field according to a mixed production strategy, respectively. Particularly, FIG. 6 is a histogram 602 showing the number of wells producing at the oil rate (in 1,000 barrels per day) within the bins along the X-axis as determined by the multi-objective genetic algorithm. For example, there are about 60 wells producing less than 1,000 barrels per day, about 160 wells producing between 1,000 barrels per day and 2,000 barrels per day, and about 60 wells producing between 3,000 and 4,000 barrels per day.

FIG. 7 is a histogram 702 similar to the histogram 602 of FIG. 6 except it shows potential oil production rather than production as provided by the multi-objective genetic algorithm. According to the histogram, for example, there are about 40 wells having a potential of producing less than 1,000 barrels per day, about 80 wells having a potential of producing between 1,000 and 2,000 barrels per day, and about 110 wells having a potential of producing between 3,000 and 4,000 barrels per day. In comparing the histogram 702 of FIG. 7 with the histogram 602 of FIG. 6, it is shown that the multi-objective genetic algorithm decreases the potential oil rate of wells within the field to satisfy the multi-objective fitness function while considering the user-defined constraints. For example, a number of wells capable of producing oil at a rate of more than 3,000 barrels per day have their output rate significantly reduced according to the multi-objective genetic algorithm as shown in the histogram 602 of FIG. 7.

Referring now to FIG. 8A, an example oil extraction system 801 incorporating functionalities of the present disclosure is schematically illustrated. Generally, the oil extraction system 801 includes completed wells 850 and a field oil rate computing system 802. It should be understood that only one completed well 850 is illustrated for ease of illustration, and that the oil extraction system 801 includes many completed wells 850 that communicate with the field oil rate computing system 802.

Attributes of wells 850 are measured and transmitted to the field oil rate computing system 802 as well data, which uses the well data it receives to determine an optimal oil rate for the each of the wells within a field. Oil rate instructions for specific wells are transmitted to one or more well components of the completed wells 850 to autonomously perform well functions to achieve the optimal oil rates.

More specifically, attributes of the well 850 are measured using well monitoring hardware 859 which includes one or more sensors that generate well data relevant to determining oil rates, such as, without limitation, present oil rate per well, bottom hole pressure per well, water cut per well, as well as trunkline data as described above. The well monitoring hardware 859 includes sensors such as, without limitation, flow sensors, pressure sensors, resistivity sensors, acoustic sensors, and phase ratio sensors.

The well data generated by the well monitoring hardware 859 is transmitted to the field oil rate computing system 802. For example, the well data may be transmitted by communication hardware 851a, which is received by communication hardware 851b of the field oil rate computing system 802.

A well data memory 836 stores the well data received from well monitoring hardware 859. The well data memory 836 may be configured as any conventional or yet-to-be-developed structure for storing sensor data, e.g., as a random access memory (RAM), a read only memory (ROM), data registers, a database, and/or other hardware for storing sensor data.

The field oil rate computing system 802 further includes an oil rate updater 830 having hardware and software suitable for executing operations on the well data obtained from well monitoring hardware 859. More specifically, the oil rate updater 830 comprises one or more processors for executing specific software-based logic modules, such as, without limitation, multi-objective genetic logic for determining optimal oil rates for wells 859 and for transmitting instructions to hardware of completed wells for autonomous control.

The field oil rate computing system 802 also includes an oil rate translation module 828 that may comprise any hardware and/or software configured to translate the output of the oil rate updater 830 (e.g., well oil rates) into a form that can be used in control of technical operations performed by well components the wells 850. The oil rate translation module 828 may comprise a hardware driver or controller (i.e., a processor), a document printer, a data display, or any other hardware that generates an operations output that can be used in the oil extraction system 801 to alter, enhance, or otherwise control technical operations or create a technical effect within the oil extraction system 801. The oil rate translation module 828 may generate executable code for controlling well components 890 for optimal performance. In other cases, the oil rate translation module 828 compiles oil rates for transmission to the well components 890 of individual wells 850, which then autonomously uses the oil rates to generate control signals for optimally operating the well components.

The well data and/or executable instructions are provided to one or more well components 890 of the well 850 to control the oil rate of the well 850 (e.g., by way of communications hardware 851a, 851b), such as, without limitation, a wellhead choke 891. Without being bound by theory, other well components may be utilized or controlled to adjust the oil rate of the well. For example, in wells 850 including artificial lift hardware, one or more of the well components 890 of the artificial lift may be controlled to adjust the oil rate from the well. This may include, but may not be limited to, a compressor injection rate or pressure in gas lift, a reciprocation frequency in plunger lift or for a sucker rod pump, a motor speed in an electrical submersible pump (ESP) or progressive cavity pump (PCP), a power fluid injection rate in hydraulic pumps, or combinations thereof, as may be understood by one of ordinary skill in the art.

The one or more well components 890 of the well 850 are thus automatically operated to achieve the optimal oil rate.

Embodiments of the present disclosure may be implemented by a computing device, and may be embodied as computer-readable instructions stored on a non-transitory memory device. FIG. 8B depicts an example field oil rate computing system 802 configured to perform the functionalities described herein. The example field oil rate computing system 802 provides a system for determining oil rates for wells of a field as well as operating wells of a field, and/or a non-transitory computer usable medium having computer readable program code for determining oil rates for wells of a field as well as operating wells of a field embodied as hardware, software, and/or firmware, according to embodiments shown and described herein. While in some embodiments, the field oil rate computing system 802 may be configured as a general purpose computer with the requisite hardware, software, and/or firmware, in some embodiments, the field oil rate computing system 802 may be configured as a special purpose computer designed specifically for performing the functionality described herein. It should be understood that the software, hardware, and/or firmware components depicted in FIG. 8B may also be provided in other computing devices external to the field oil rate computing system 802 (e.g., data storage devices, remote server computing devices, and the like).

As also illustrated in FIG. 8B, the field oil rate computing system 802 (or other additional computing devices) may include an oil rate updater 830, input/output hardware 832, network interface hardware 834, a well data memory 836 (which may store well data 838A, weight and constraint data 838B, and any other data 838C), and a non-transitory memory component 840. The memory component 840 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. Additionally, the memory component 840 may be configured to store operating logic 841 and multi-objective genetic logic 842 (each of which may be embodied as computer readable program code, firmware, or hardware, as an example). A local interface 846 is also included in FIG. 8B and may be implemented as a bus or other interface to facilitate communication among the components of the field oil rate computing system 802.

The oil rate updater 830 may include any processing component configured to receive and execute computer readable code instructions (such as from the well data memory 836 and/or memory component 840). The input/output hardware 832 may include an electronic display device, keyboard, mouse, printer, camera, microphone, speaker, touch-screen, and/or other device for receiving, sending, and/or presenting data. The network interface hardware 834 may include any wired or wireless networking hardware, such as a modem, LAN port, wireless fidelity (Wi-Fi) card, WiMax card, mobile communications hardware, and/or other hardware for communicating with other networks and/or devices, such as external devices for operating well components 890 (e.g., valves).

It should be understood that the well data memory 836 may reside local to and/or remote from the field oil rate computing system 802, and may be configured to store one or more pieces of data for access by the field oil rate computing system 802 and/or other components. As illustrated in FIG. 8B, the well data memory 836 may include well data 838A, which in at least one embodiment includes well input data provided by a user or automatically acquired through various means. Similarly, weight and constraint data 838B may be stored by the well data memory 836 and may include data relating the global weight factors and constraints provided by the user. Other data 838C to perform the functionalities described herein may also be stored in the well data memory 836.

Included in the memory component 840 may be the operating logic 841 and the multi-objective genetic algorithm logic 842. The operating logic 841 may include an operating system and/or other software for managing components of the field oil rate computing system 802. Similarly, multi-objective genetic algorithm logic 842 may reside in the memory component 840 and is configured to determine the oil rates in accordance with the global weight factors and constraints provided by the user.

It should now be understood that embodiments of the present disclosure are directed to systems and methods for determining oil rates for wells of a field, as well as systems and methods for operating wells of a field. In embodiments, reservoir strategies are automatically generated that honor a field's production target and provide a uniform movement of flood front while optimizing the reservoir pressure of the field and minimizing the production of water at the surface to achieve an oil production sustainably, prolonging the field's life and preventing excessive water production. Particularly, embodiments of the present disclosure improve the computational efficiency of determining well production rates, and minimize manual involvement by use of a multi-objective genetic algorithm that automates the process of determining oil rates of wells within the field, thereby ensuring the targeted production strategy is captured. Embodiments disclosed herein receive as input well data, and also global weight factors that define a production strategy and constraints defining characteristics of the field, such as trunkline and production facility characteristics. A multi-objective genetic algorithm receives the inputs and determines one or more solution sets having an output that includes well product rates for the plurality of wells within the field. These oil rates may then be automatically provided to the wells so that components of the wells are operated to achieve the desired oil rate.

In a first aspect of the disclosure, a method of operating a plurality of wells within a field includes determining an oil rate for each well of the plurality of wells by a multi-objective genetic algorithm. The multi-objective genetic algorithm is defined by a multi-objective fitness function including a first objective function that meets a target oil rate for the field and a second objective function that maximizes bottom-hole reservoir pressure, maximizes a distance of the wells to a crest line of the field, and minimizes a water cut of the field. The multi-objective genetic algorithm outputs the oil rate for each well that satisfies the multi-objective fitness function. The method further includes operating the plurality of wells at the oil rate for each well.

In a second aspect, a method according to the first aspect, wherein the multi-objective fitness function is iteratively executed until the multi-objective fitness function is satisfied.

In a third aspect, a method according to the first aspect or the second aspect, the multi-objective genetic algorithm produces a plurality of solution generations by applying selection, cross-over and mutation.

In a fourth aspect, a method according to any preceding aspect, further including receiving input data into the multi-objective genetic algorithm, and receiving one or more constraints into the multi-objective genetic algorithm.

In a fifth aspect, a method according to the fourth aspect, wherein the input data includes for each well of the plurality of wells, one or more of well coordinates, water rate, maximum oil rate, well structure depth, bottom-hole pressure and water cut.

In a sixth aspect, a method according to the fourth aspect or the fifth aspect, wherein the one or more constraints include one or more operation conditions including minimum operating bottom-hole pressure, and one or more non-linear constraints including one or more of minimum trunkline rate, maximum facility production rate, minimum group production rate, and maximum group production rate.

In a seventh aspect, a method according to any preceding aspect, further comprising applying one or more global weight factors to the multi-objective genetic algorithm to define a production strategy.

In an eighth aspect, a method according to the seventh aspect, wherein the production strategy is selected from a wet production strategy, a dry production strategy, and a mixed production strategy.

In a ninth aspect, a method according to the seventh or eighth aspect, wherein the one or more global weight factors comprise a pressure weight factor, a distance weight factor, and a water cut weight factor.

In a tenth aspect, a method according to any preceding aspect, wherein the oil rate for each well of the plurality of wells is such that the field produces a uniform flood front from flank to crest.

In an eleventh aspect, a system for operating a plurality of wells within a field includes one or more processors, and a non-transitory computer-readable memory storing instructions that, when executed by the one or more processors, cause the one or more processors to determine an oil rate for each well of the plurality of wells by a multi-objective genetic algorithm. The multi-objective genetic algorithm is defined by a multi-objective fitness function including a first objective function that meets a target oil rate for the field and a second objective function that maximizes bottom-hole reservoir pressure, maximizes a distance of the wells to a crest line of the field, and minimizes a water cut of the field. The multi-objective genetic algorithm outputs the oil rate for each well that satisfies the multi-objective fitness function. The system further includes one or more well components of the plurality of wells, wherein the one or more well components are operated based on the oil rate for each well of the plurality of wells.

In a twelfth aspect, a system according to the eleventh aspect, wherein the multi-objective fitness function is iteratively executed until the multi-objective fitness function is satisfied.

In a thirteenth aspect, a system according to the eleventh or twelfth aspect, wherein the multi-objective genetic algorithm produces a plurality of solution generations by applying selection, cross-over and mutation.

In a fourteenth aspect, a system according to any one of the eleventh through thirteenth aspects, wherein the instructions further cause the one or more processors to receive input data into the multi-objective genetic algorithm, and receive one or more constraints into the multi-objective genetic algorithm.

In a fifteenth aspect, a system according to the fourteenth aspect, wherein the input data includes for each well of the plurality of wells, one or more of well coordinates, water rate, maximum oil rate, well structure depth, bottom-hole pressure and water cut.

In a sixteenth aspect, a system according to the fourteenth or fifteenth aspect, wherein the one or more constraints comprise one or more operating constraints comprising minimum operating bottom-hole pressure, and one or more non-linear constraints comprising one or more of minimum trunkline rate, maximum facility production rate, minimum group production rate, and maximum group production rate.

In a seventeenth aspect, a system according to any one of the eleventh through sixteenth aspects, wherein the instructions further cause the one or more processors to apply one or more global weight factors to the multi-objective genetic algorithm to define a production strategy.

In an eighteenth aspect, a system according to the seventeenth aspect, wherein the production strategy is selected from a wet production strategy, a dry production strategy, and a mixed production strategy.

In a nineteenth aspect, a system according to the seventeenth or eighteenth aspect, wherein the one or more global weight factors comprise a pressure weight factor, a distance weight factor, and a water cut weight factor.

In a twentieth aspect, a system according to any one of the eleventh through nineteenth aspects, wherein the oil rate for each well of the plurality of wells is such that the field produces a uniform flood front from flank to crest.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

1. A method of operating a plurality of wells within a field, the method comprising:
generating, using well monitoring hardware, well data from the plurality of wells;
storing the well data in a well data memory module;
determining, using an oil rate updater, an oil rate for each well of the plurality of wells by the well data and a multi-objective genetic algorithm, wherein:
the multi-objective genetic algorithm is defined by a multi-objective fitness function comprising a first objective function that meets a target oil rate for the field and a second objective function that maximizes bottom-hole reservoir pressure, maximizes a distance of individual wells to a crest line of the field, and minimizes a water cut of the field,
the multi-objective genetic algorithm outputs the oil rate for each well that satisfies the multi-objective fitness function; and
translating, using an oil rate translation module, the oil rate for each well that satisfies the multi-objective fitness function for use by one or more well components of the plurality of wells;
operating the one or more well components of the plurality of wells at the oil rate for each well.

2. The method according to claim 1, wherein the multi-objective fitness function is iteratively executed until the multi-objective fitness function is satisfied.

3. The method according to claim 1, wherein the multi-objective genetic algorithm produces a plurality of solution generations by applying selection, cross-over and mutation.

4. The method according to claim 1, further comprising:
receiving the well data into the multi-objective genetic algorithm; and
receiving one or more constraints into the multi-objective genetic algorithm.

5. The method according to claim 1, wherein the well data includes for each well of the plurality of wells, one or more of well coordinates, water rate, maximum oil rate, well structure depth, bottom-hole pressure and water cut.

6. The method according to claim 4, wherein the one or more constraints comprise:
one or more operating constraints comprising minimum operating bottom-hole pressure; and
one or more non-linear constraints comprising one or more of minimum trunkline rate, maximum facility production rate, minimum group production rate, and maximum group production rate.

7. The method according to claim 1, further comprising applying one or more global weight factors to the multi-objective genetic algorithm to define a production strategy.

8. The method according to claim 7, wherein the production strategy is selected from a wet production strategy, a dry production strategy, and a mixed production strategy.

9. The method according to claim 7, wherein the one or more global weight factors comprise a pressure weight factor, a distance weight factor, and a water cut weight factor.

10. The method according to claim 1, wherein:
the well monitoring hardware comprises one or more of a pressure sensor, a flow sensor, a resistivity sensor, an acoustic sensor, and a phase ratio sensor; and
the one or more well components comprises a wellhead choke.

11. A system for operating a plurality of wells within a field comprising:
one or more well components for each well of the plurality of wells;
well monitoring hardware that generates well data from the plurality of wells;
a field oil rate computing system comprising:
a well data memory module that receives and stores the well data from the well monitoring hardware;
an oil rate updater that determines an oil rate for each well of the plurality of wells by a multi-objective genetic algorithm, wherein:
the multi-objective genetic algorithm is defined by a multi-objective fitness function comprising a first objective function that meets a target oil rate for the field and a second objective function that maximizes bottom-hole reservoir pressure, maximizes a distance of the wells to a crest line of the field, and minimizes a water cut of the field,
the multi-objective genetic algorithm outputs the oil rate for each well that satisfies the multi-objective fitness function,
and
an oil rate translation module that translates the oil rate for each well that satisfies the multi-objective fitness function for use by the one or more well components of the plurality of wells, wherein the one or more well components are operated based on the oil rate for each well of the plurality of wells.

12. The system according to claim 11, wherein the multi-objective fitness function is iteratively executed until the multi-objective fitness function is satisfied.

13. The system according to claim 11, wherein the multi-objective genetic algorithm produces a plurality of solution generations by applying selection, cross-over and mutation.

14. The system according to claim 11, wherein the instructions further cause the one or more processors to:
receive the well data into the multi-objective genetic algorithm; and
receive one or more constraints into the multi-objective genetic algorithm.

15. The system according to claim 11, wherein the well data includes for each well of the plurality of wells, one or more of well coordinates, water rate, maximum oil rate, well structure depth, bottom-hole pressure and water cut.

16. The system according to claim 14, wherein the one or more constraints comprise:
one or more operating constraints comprising minimum operating bottom-hole pressure; and
one or more non-linear constraints comprising one or more of minimum trunkline rate, maximum facility production rate, minimum group production rate, and maximum group production rate.

17. The system according to claim 11, wherein the instructions further cause the one or more processors to apply one or more global weight factors to the multi-objective genetic algorithm to define a production strategy.

18. The system according to claim 17, wherein the production strategy is selected from a wet production strategy, a dry production strategy, and a mixed production strategy.

19. The system according to claim 17, wherein the one or more global weight factors comprise a pressure weight factor, a distance weight factor, and a water cut weight factor.

20. The system according to claim 11, wherein:
the well monitoring hardware comprises one or more of a pressure sensor, a flow sensor, a resistivity sensor, an acoustic sensor, and a phase ratio sensor; and
the one or more well components comprises a wellhead choke.
